(19) United States
(12) Patent Application Publication
(10) Pub. No.: US 2003/0135654 A1
(43) Pub. Date: Jul. 17, 2003

(54) Remotely full control device

(75) Inventor: Ming-Chih Chang, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: ICP Electronics Inc.

(21) Appl. No.: 10/121,308

(22) Filed: Apr. 12, 2002

(30) Foreign Application Priority Data
Jan. 17, 2002 (TW) 91100664

(51) Int. Cl. G06F 15/16; G06F 1/28

(52) U.S. Cl. 709/250; 713/300

(57) ABSTRACT

A remotely full control device. The device uses a remote monitor to control and monitor computers on a LAN through a WAN to handle abnormal operations in any computer(s) on the LAN. The remotely full control device includes: a WAN connection interface; a LAN connection interface; a KVM input and output interface; an audio input and output interface; and a power control signal generator. The WAN connection interface goes online to a WAN to receive a control signal from a remote monitor. The LAN connection interface goes online to a LAN having multiple computers. The KVM input and output interface transfers and receives data from the multiple computers. The audio input and output interface transfers and receives signals from voice devices of the multiple computers, and the power control signal generator uses a Wake-On-LAN technique to wake up one or more assigned computers. The invention further includes an image input device to help the remote monitor monitoring the multiple computers.

### BACKGROUND OF THE INVENTION

1. Field of the Invention

The present invention relates to a remotely full control device which uses a remote monitor to control and monitor computers on a LAN through a WAN for handling abnormal operations of any assigned computer(s) on the LAN.

1. Description of Related Art

Currently, network remote control in operation is widely used. When a computer in use operates abnormally, for example, a computer virus appears or an operating system is not compatible with the computer, the computer can be fixed by remote operation through a network, instead of typically sending the computer to a computer store or an agent, even if a server (not shown) is broken down and cannot perform the control function. As shown in FIG. 1, for example, the operator (such as a supervisor in a host room) of a remote monitor 21 remotely fixes a computer 23 or 24 through a remote monitor and control device 22 connected to a LAN by a KVM bus. Such a remote operation concurrently controls different types of local computers 23 and 24 by controlling a Server Switch (not shown) with the networking function through the remote monitor 21. While this has cross-platform operation capability and real-time control of different types of computers, it cannot operate in a power-off state nor monitor host audio signals and operation environment.

### SUMMARY OF THE INVENTION

Accordingly, an object of the invention is to provide a remotely full control device which uses a remote monitor to control and monitor local computers on a LAN through a WAN, and to wake up the required power and handle abnormal operations of any assigned computer(s) on a LAN. The monitor and control system according to the remotely full control device includes: multiple local computers, to perform the operations; a remote monitor, to monitor the multiple local computers and output control signals to the respective local computers; a WAN, connected to the remote monitor to convey the control signals from the remote monitor; a LAN, connected to the multiple local computers to convey the control signals from the remote monitor to the multiple local computers; and a remotely full control device, the present invention, having a WAN connection interface, a LAN connection interface; a KVM input and output interface; an audio input and output interface; and a power control signal generator. The WAN and LAN connection interfaces go online respectively to the WAN and LAN. The power control signal generator uses a Wake-On-LAN technique to send a wake-up signal to the LAN connection interface and the LAN to power on one or more assigned computers. The KVM and audio input and output interfaces transfer and receive data and voice signals from the multiple local computers respectivley. This invention further includes an image input device to help the remote monitor monitoring the multiple local computers.

The invention uses the Wake-On-LAN technique to power up all assigned computers through the LAN, so as to overcome the disadvantages of prior art and further save power.

### BRIEF DESCRIPTION OF THE DRAWINGS

The invention will become apparent by referring to the following detailed description of a preferred embodiment with reference to the accompanying drawings, wherein:

FIG. 1 is a schematic diagram illustrating a typical remote control device;

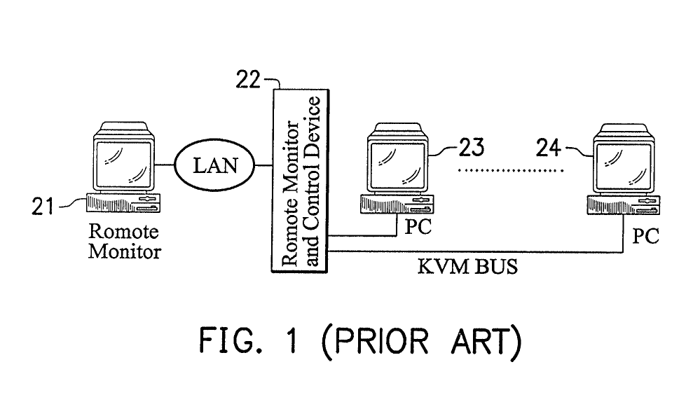

FIG. 2 is a schematic diagram illustrating an embodiment of a monitor and control system according to the invention; and

FIG. 3 is a schematic diagram illustrating another embodiment of the monitor and control system according to the invention.

### DETAILED DESCRIPTION OF THE INVENTION The same element denotes the same reference number throughout the description and drawings.

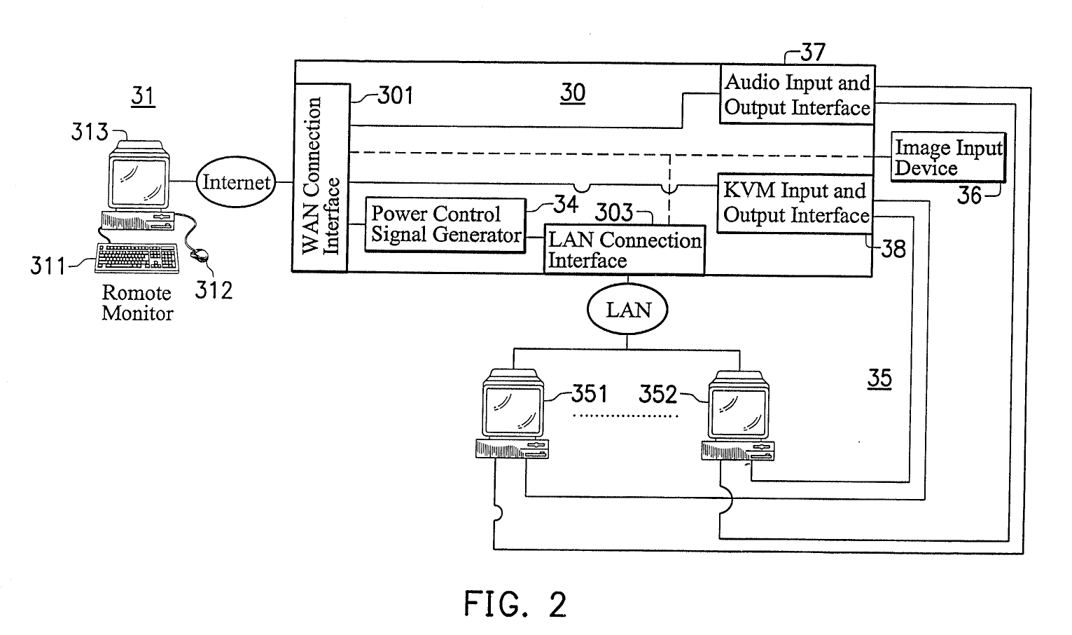

FIG. 2 is a schematic diagram illustrating an embodiment of a monitor and control system according to the invention. In FIG. 2, the remotely full control device 30 includes: a WAN connection interface 301, to connect to the Internet and a remote monitor 31 with the keyboard 311, mouse 312, and monitor 313 (KVM) via the Internet; a LAN connection interface 303, to connect to a LAN for controlling multiple local computers 35, an image input device 36, an audio input and output interface 37, a KVM input and output interface 38 and a power control signal generator 34.

As shown in FIG. 2, to control the multiple local computers 35, a remote monitor 31 sends a control signal to the WAN connection interface 301 of the device 30 through a WAN, for example, the Internet. The WAN connection interface 301 of the device 30 transfers the received control signal by an internal connection line to the power control signal generator 34, then the control signal from the power control signal generator 34 is converted by the LAN connection interface 303 into a LAN signal so as to control the multiple local computers 35 through the LAN. To further increase controllability, in addition to KVM input and output interface 38, the device 30 further includes an audio input and output interface 37 to input and output signals from voice devices of the multiple local computers 35, such as, speaker, mic, and computer-synthesized voice device. As such, a supervisor can hear the sound on-site and convey a control command by voice. For example, the operator of the remote monitor 31 inputs signal through the keyboard 311 or the mouse 312 to monitor the first and last local computers 351, 352 on the monitor 313, and he notices the two computer 351, 352 are offline. As such, the remote monitor 31 first sends a control signal to the WAN connection interface 301 through the Internet. Next, the power control signal generator 34 receives the control signal and generates a wake-up signal having the address and network protocol-related information for execution. The wake-up signal is transferred to the LAN through the LAN connection interface 303 to start the first and last local computers 351, 352 and then monitor the computers 351, 352. When the device 30 includes an image input device 36, such as a camera, the remote monitor 31 can monitor the on-site situation of the local computers 35 through the inputs of the image input device 36 and/or the audio input and output interface 37. As such, a control signal such as the citing wake-up signal can be sent out in real-time as needed. The WAN can use an Ethernet protocol or TCP/IP to transfer data.

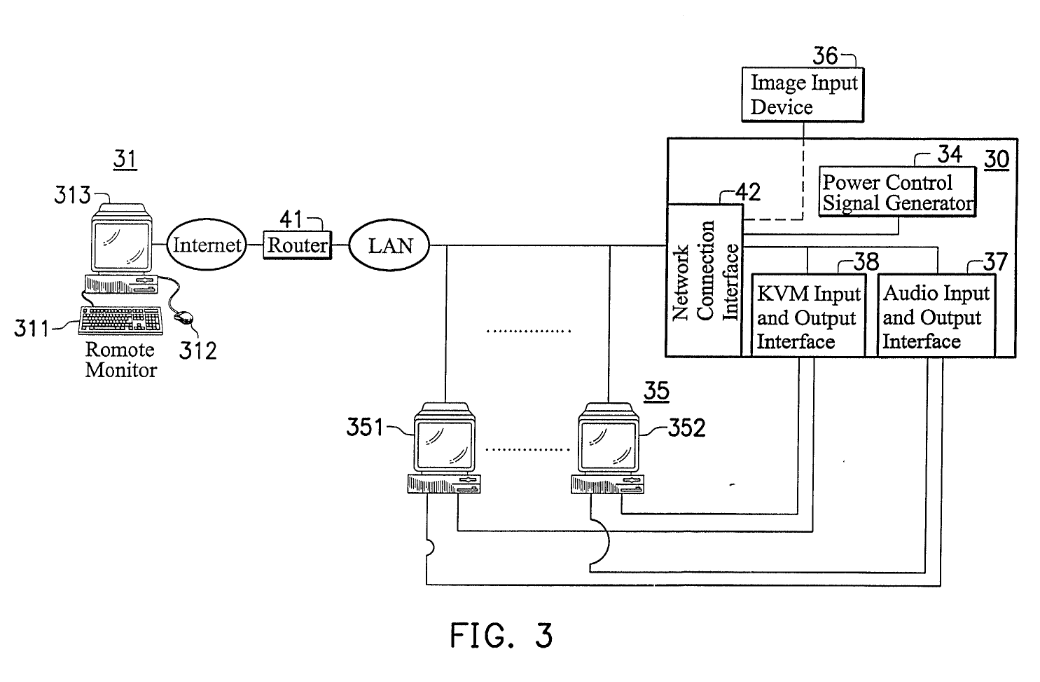

FIG. 3 is a schematic diagram illustrating another embodiment of the monitor and control system according to the invention. In FIG. 3, compared to FIG. 2, the major difference is a router 41 coupled between the Internet and the LAN. By such a configuration, the implementation does not need to divide into the LAN and WAN connection interfaces inside the device 30. The device 30 only needs a network connection interface 42 such as a card with a network connection port, to directly connect to the router 41 through the LAN, just the same as other network devices, as shown in FIG. 3. As such, signal conversion from the WAN signal WEBSIG to the LAN signal LANSIG is performed by the router 41.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A remotely full control device, comprising:
a KVM input and output interface, connected to a plurality of local computers for inputting a keyboard or mouse input signal and outputting a display signal;
an audio input and output interface, connected to the plurality of local computers for inputting and outputting voice signal;
a WAN connection interface, for connecting to a WAN to receive a signal transferred by a remote monitor;
a LAN connection interface, for connecting to a LAN connected to the plurality of local computers; and
a power control signal generator, for generating a wake-up signal and transferring the wake-up signal to the LAN connection interface so as to connect and control the plurality of local computers assigned through the LAN.

2. The remotely full control device of claim 1, further comprising an image input device to help the remote monitor to obtain real-time information from the plurality of local computers.

3. The remotely full control device of claim 1, wherein the remote monitor comprises a keyboard, a mouse and a monitor (KVM).

4. The remotely full control device of claim 1, wherein the LAN is Ethernet.

5. The remotely full control device of claim 1, wherein the LAN is Token Ring.

6. The remotely full control device of claim 1, wherein the WAN is an Ethernet implementation.

7. The remotely full control device of claim 1, wherein the WAN is a TCP/IP implementation.

8. A remotely full control device, comprising:
a KVM input and output interface, connected to a plurality of local computers to input a keyboard or mouse input signal and output a display signal;
an audio input and output interface, connected to the plurality of local computers to input and output voice signal;
a network connection interface, to connect to a network connected to the plurality of local computers; and
a power control signal generator, to generate a wake-up signal and transfer the wake-up signal to the network connection interface so as to connect and control the plurality of local computers assigned through the network.

9. The remotely full control device of claim 8, further comprising an image input device to help a remote monitor to obtain the real-time information from the plurality of local computers.

10. The remotely full control device of claim 8, further comprising a router between the network and a WAN.

11. The remotely full control device of claim 8, wherein the remote monitor comprises a keyboard, a mouse and a monitor (KVM).

12. The remotely full control device of claim 8, wherein the network is Ethernet.

13. The remotely full control device of claim 8, wherein the network is Token Ring.
